(19) United States
(12) Patent Application Publication
(10) Pub. No.: US 2002/0165001 A1
(43) Pub. Date: Nov. 7, 2002

(54) Wireless communication network with tracking flat-panel antenna

(76) Inventors: Chester Phillips, Germantown, MD (US); Paul Johnson, Kihei, HI (US); Randall Olsen, Carlsbad, CA (US); John Lovberg, San Diego, CA (US); Kenneth Y. Tang, Alpine, CA (US); George Houghton, San Diego, CA (US); Vladimir Kolinko, San Diego, CA (US)

Correspondence Address: Ross Patent Law Office, P.O. Box 2138, Del Mar, CA, 92014, US

(21) Appl. No.: 10/001,617

(22) Filed: Oct. 30, 2001

Related U.S. Application Data
(63) Continuation-in-part of application No. 09/847,629, filed on May 2, 2001.
(63) Continuation-in-part of application No. 09/872,542, filed on Jun. 2, 2001.
(63) Continuation-in-part of application No. 09/872,621, filed on Jun. 2, 2001.
(63) Continuation-in-part of application No. 09/882,482, filed on Jun. 14, 2001.
(63) Continuation-in-part of application No. 09/952,591, filed on Sep. 14, 2001.
(63) Continuation-in-part of application No. 09/965,875, filed on Sep. 28, 2001.

(51) Int. Cl. H04B 7/00

(52) U.S. Cl. 455/500; 455/269

(57) ABSTRACT

A point-to-point, wireless, millimeter wave communications links equipped with tracking antennas to maintain pencil beam contact between the links. In a preferred embodiment the antennas are flat panel tracking antennas and the communication links operate within the 92 to 95 GHz portion of the millimeter spectrum and provides data transmission rates in excess of 155 Mbps. A first transceiver transmits at a first bandwidth and receives at a second bandwidth both within the above spectral range. A second transceiver transmits at the second bandwidth and receives at the first bandwidth. The transceivers are equipped with antennas providing beam divergence small enough to ensure efficient spatial and directional partitioning of the data channels so that an almost unlimited number of transceivers will be able to simultaneously use the same spectrum. In a preferred embodiment the first and second spectral ranges are 92.3-93.2 GHz and 94.1-95.0 GHz and the half power beam width is about 0.36 degrees or less.

The present invention relates to flat-panel antennas and specifically to such antennas used in communication systems. This application is a continuation-in-part application of Ser. No. 09/847,629 filed May 2, 2001, Ser. No. 09/872,542 filed Jun. 2, 2001, Ser. No. 09/872,621 filed Jun. 2, 2001, Ser. No. 09/882,482 filed Jun. 14, 2001, Ser. No. 09/952,591, filed Sep. 14, 2001, Ser. No. 09/965,875 filed Sep. 28, 2001 and Serial No. ______ filed Oct. ______, 2001 all of which are incorporated herein by reference.

### BACKGROUND OF THE INVENTION

### Wireless Communication

### Point-to-Point and Point-to-Multi-Point

Wireless communications links, using portions of the electromagnetic spectrum, are well known. Most such wireless communication at least in terms of data transmitted is one way, point to multi-point, which includes commercial radio and television. However there are many examples of point-to-point wireless communication. Mobile telephone systems that have recently become very popular are examples of low-data-rate, point-to-point communication. Microwave transmitters on telephone system trunk lines are another example of prior art, point-to-point wireless communication at much higher data rates. The prior art includes a few examples of point-to-point laser communication at infrared and visible wavelengths.

### Need for High Volume Information Transmission

The need for faster (i, e., higher volume per unit time) information transmission is growing rapidly. Today and into the foreseeable future transmission of information is and will be digital with volume measured in bits per second. To transmit a typical telephone conversation digitally utilizes about 5,000 bits per second (5 Kbits per second). Typical personal computer modems connected to the Internet operate at, for example, 56 Kbits per second. Music can be transmitted point to point in real time with good quality using mp3 technology at digital data rates of 64 Kbits per second. Video can be transmitted in real time at data rates of about 5 million bits per second (5 Mbits per second). Broadcast quality video is typically at 45 or 90 Mbps. Companies (such as telephone and cable companies) providing point-to-point communication services build trunk lines to serve as parts of communication links for their point-to-point customers. These trunk lines typically carry hundreds or thousands of messages simultaneously using multiplexing techniques. Thus, high volume trunk lines must be able to transmit in the gigabit (billion bits. Gbits, per second) range. Most modern trunk lines utilize fiber optic lines. A typical fiber optic line can carry about 2 to 10 Gbits per second and many separate fibers can be included in a trunk line so that fiber optic trunk lines can be designed and constructed to carry any volume of information desired virtually without limit. However, the construction of fiber optic trunk lines is expensive (sometimes very expensive) and the design and the construction of these lines can often take many months especially if the route is over private property or produces environmental controversy. Often the expected revenue from the potential users of a particular trunk line under consideration does not justify the cost of the fiber optic trunk line. Digital microwave communication has been available since the mid-1970's. Service in the 18-23 GHz radio spectrum is called “short-haul microwave” providing point-to-point service operating between 2 and 7 miles and supporting between four to eight T1 links (each at 1.544 Mbps). Recently, microwave systems operation in the 11 to 38 Ghz band have reportably been designed to transmit at rates up to 155 Mbps (which is a standard transmit frequency known as “OC-3 Standard”) using high order modulation schemes.

### Data Rate vs Frequency

Bandwidth-efficient modulation schemes allow, as a general rule, transmission of data at rates of 1 to 10 bits per Hz of available bandwidth in spectral ranges including radio wave lengths to microwave wavelengths. Data transmission requirements of 1 to tens of Gbps thus would require hundreds of MHz of available bandwidth for transmission. Equitable sharing of the frequency spectrum between radio, television, telephone, emergency services, military and other services typically limits specific frequency band allocations to about 10% fractional bandwidth (i.e., range of frequencies equal to about 10% of center frequency). AM radio, at almost 100% fractional bandwidth (550 to 1650 GHz) is an anomaly; FM radio. at 20% fractional bandwidth, is also a typical compared to more recent frequency allocations, which rarely exceed 10% fractional bandwidth.

### Reliability Requirements

Reliability typically required for wireless data transmission is very high, consistent with that required for hardwired links including fiber optics. Typical specifications for error rates are less than one bit in ten billion (10⁻¹⁰ bit-error rates), and link availability of 99.999% (5 minutes of down time per year). This necessitates all-weather link operability, in fog and snow, and at rain rates up to 100 mm/hour in many areas.

### Weather Conditions

In conjunction with the above availability requirements, weather-related attenuation limits the useful range of wireless data transmission at all wavelengths shorter than the very long radio waves. Typical ranges in a heavy rainstorm for optical links (i.e., laser communication links) are 100 meters and for microwave links, 10,000 meters.

Atmospheric attenuation of electromagnetic radiation increases generally with frequency in the microwave and millimeter-wave bands. However, excitation of rotational transitions in oxygen and water vapor molecules absorbs radiation preferentially in bands near 60 and 118 GHz (oxygen) and near 23 and 183 GHz (water vapor). Rain, which attenuates through large-angle scattering, increases monotonically with frequency from 3 to nearly 200 GHz. At the higher, millimeter-wave frequencies, (i.e., 30 GHz to 300 GHz corresponding to wavelengths of 1.0 millimeter to 1.0 centimeter) where available bandwidth is highest, rain attenuation in very bad weather limits reliable wireless link performance to distances of 1 mile or less. At microwave frequencies near and below 10 GHz, link distances to 10 miles can be achieved even in heavy rain with high reliability, but the available bandwidth is much lower.

### Communication Antennas

### Low Frequencies

At frequencies below about below 3 GHz, antennas of practical size are nearly omnidirectional, so beams from different antennas interfere, and the only equitable way to share the airwaves is by parceling the frequency spectrum. Licenses for a given spectrum band are auctioned to a single service provider in each geographical area, thereby eliminating competition in that area. To guarantee efficient use of the spectrum, bandwidth efficiency is mandated in this range of the radio spectrum.

### Higher Frequencies

At higher frequencies from about 3 to 60 GHz, antenna beams become somewhat directional, so beam interference can be avoided spatially. Here point-to-point licenses may be granted for services overlapping in frequency but not in space, or for services overlapping in space but not in frequency. The two-dimensional coordination afforded in this spectral range increases the number of licensees who can coexist in a given geographical area, allowing for increased competition.

### Millimeter Wave Frequencies

At frequencies above 60 GHz to about 130 GHz, antennas of practical size can generate highly directional “pencil beams” which do not interfere at all, because of their extremely limited spatial extent. A. typical dish antenna of two-foot diameter operating at 94 GHz projects a half-power beam width of 0.36 degrees providing a gain of about 51 dB. (Gain is the ratio of the radiation intensity in a desired direction to the total input power accepted at an input port of the antenna. The ratio is usually expressed in decibels.}

### Dish Antennas

Most antennas used for high-gain applications utilize a large parabolic primary collector in one of a variety of geometries. In a prime-focus antenna the receiver is placed directly at the focus of the parabola. In a Cassegrain antenna a convex hyperboloidal secondary reflector is placed in front of the focus to reflect the focus back through an aperture in the primary to allow mounting the receiver behind the dish. (This is convenient since the dish is typically supported from behind as well.) An offset parabola rotates the focus away from the center of the dish for less aperture blockage and improved mounting geometry.

The required surface tolerance on the dish of a high quality conductive parabola antenna is about 15 thousandths of an inch (15 mils) for microwave applications (below 40 GHz), but closer to 5 mils for MMW communications (57-100 GHz). Molded composites have achieved 5-mil tolerances, but are inherently quite expensive. Typical hydroformed aluminum dishes are inexpensive but cannot achieve adequate surface tolerances for MMW applications. The secondary reflector in the Cassegrain geometry is a small, machined aluminum “lollipop” which can be made to 1-mil tolerance without difficulty. Mounts for secondary reflectors and receiver waveguide horns preferably comprise mechanical fine-tuning adjustment for in-situ alignment on an antenna test range.

### Coarse and Fine Pointing

Pointing a high-gain antenna requires coarse and fine positioning. Coarse positioning can be accomplished initially using a visual sight such as a bore-sighted rifle scope or laser pointer. The antenna is typically locked in its final coarse position prior to fine-tuning. The fine adjustment is performed with the remote transmitter turned on. A power meter connected to the receiver is monitored for maximum power as the fine positioner is adjusted and locked down. Any subsequent unintended displacement and/or rotation of the antenna due to thermal effects, wind loading, or any other external force will cause the antenna beam to wander off of the remote transmitter.

### Prior Art Tracking Antennas

In a Cassegrain antenna, a rotating, slightly off axis feed horn (“conical scan”) steers the beam mechanically without moving the large primary dish. For Cassegrain, prime focus or offset parabola antennas, a multi-aperture feed (e.g. quad-cell) could be used with a selectable switching array or a monopulse transceiver. In these dish architectures, beam tracking is based upon maximizing signal power or minimizing wave front tilt into the receiver. In all cases, using a common aperture or mounting structure for the receiver and transmitter antennas ensures that the transmitter is correctly pointed along with the receiver. Flat-panel antennas are also used for tracking and have been used extensively for radar tracking. One example is a flat-panel phased array, antenna with a Rotman lens. In this antenna phased array beam combining from multiple output ports of the Rotman lens is used to steer the beam azimuthally over many antenna beam widths without mechanically rotating the antenna itself.

### The Need

A need exists for a complete wireless communication networks which can be put into place quickly and efficiently to provide high data rate information service to a service region independent of and in competition with existing local services where local services already exists or to provide high data rate communication service in regions where such services no not now exists. Such systems would need narrow beam width high-data-rate, high-frequency communication antennas with facilities for keeping the antennas aligned permitting the utilization of the same frequency bands over and over again to provide trunk line connections between base stations and connections with larger communication networks.

### SUMMARY OF THE INVENTION

The present invention provides point-to-point, wireless, millimeter wave communications links equipped with tracking antennas to maintain pencil beam contact between the links. In a preferred embodiment, the antennas are flat panel tracking antennas and the communication links operate within the 92 to 95 GHz portion of the millimeter spectrum and provides data transmission rates in excess of 155 Mbps. A first transceiver transmits at a first bandwidth and receives at a second bandwidth both within the above spectral range. A second transceiver transmits at the second bandwidth and receives at the first bandwidth. The transceivers are equipped with antennas providing beam divergence small enough to ensure efficient spatial and directional partitioning of the data channels so that an almost unlimited number of transceivers will be able to simultaneously use the same spectrum. In a preferred embodiment the first and second spectral ranges are 92.3-93.2 GHz and 94.1-95.0 GHz and the half power beam width is about 0.36 degrees or less.

### BRIEF DESCRIPTION OF THE DRAWINGS

FIG. 1 is a schematic diagram of a millimeter-wave transmitter of a prototype transceiver system built and tested by Applicants.

FIG. 2 is a schematic diagram of a millimeter-wave receiver of a prototype transceiver system built and tested by Applicants.

FIG. 3 is measured receiver output voltage from the prototype transceiver at a transmitted bit rate of 200 Mbps.

FIG. 4 is the same wave form as FIG. 3, with the bit rate increased to 1.25 Gbps.

FIGS. 5A and 5B are s(hematic diagrams of a millimeter-wave transmitter and receiver in one transceiver of a portion of a preferred embodiment of the present invention.

FIGS. 6A and 6B are schematic diagrams of a millimeter-wave transmitter and receiver in a complementary transceiver of a portion of a preferred embodiment of the present invention.

FIGS. 7A and 7B show the spectral diagrams for a preferred embodiment of the present invention.

FIG. 8 is a layout showing an installation using a preferred embodiment of the present invention.

FIGS. 9, 10 and 11 describe elements of a dish type antenna useful for tracking in a wireless communication network.

FIGS. 12, 13 and 14 describe elements of a flat panel type antenna useful for tracking in a wireless communication network.

### DETAILED DESCRIPTION OF PREFERRED EMBODIMENTS

### Prototype Demonstration

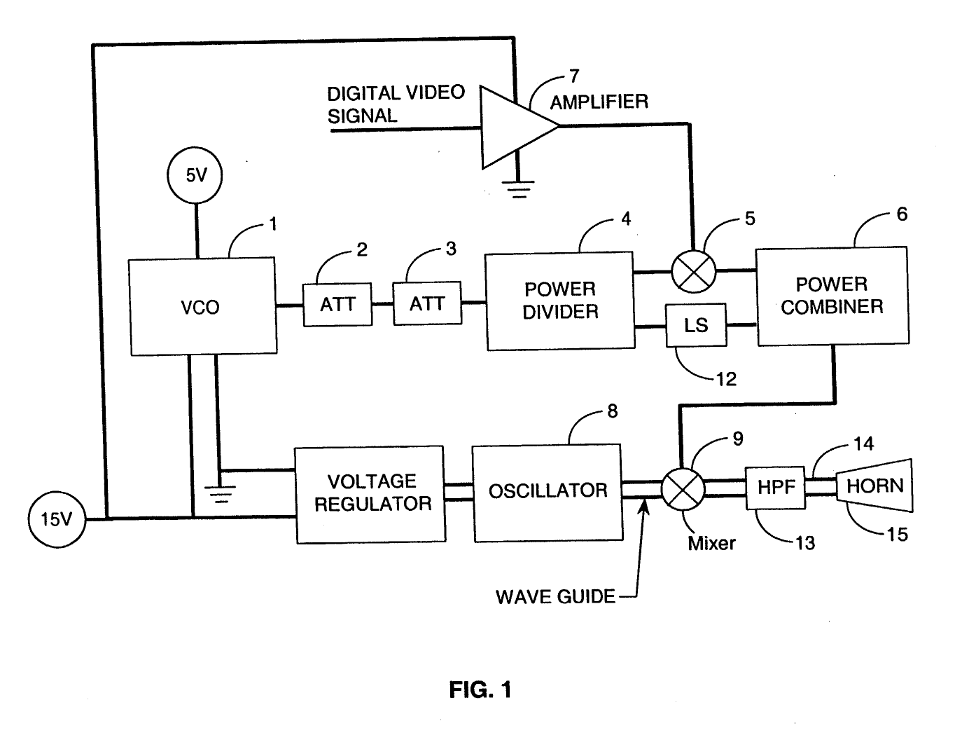

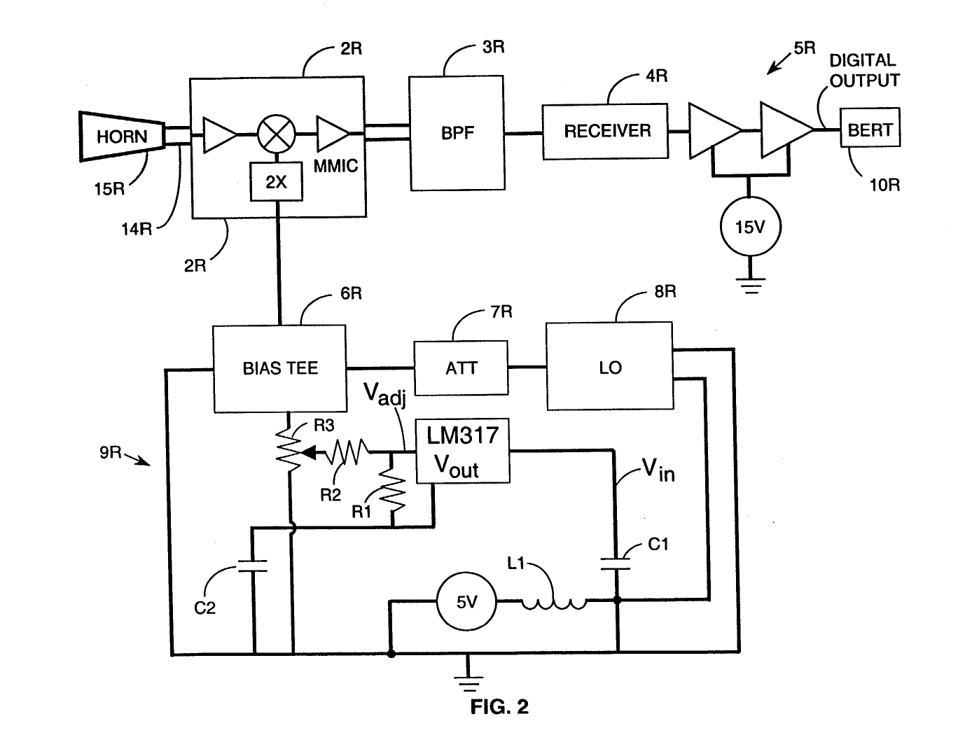

A prototype demonstration of the millimeter-wave transmitter and receiver useful for the present invention is described by reference to FIGS. 1 to 4. With this embodiment the Applicants have demonstrated digital data transmission in the 93 to 97 GHz range at 1.25 Gbps with a bit error rate below 10⁻¹².

The circuit diagram for the millimeter-wave transmitter is shown in FIG. 1. Voltage-controlled microwave oscillator 1, Westec Model VTS133/V4, is tuned to transmit at 10 GHz, attenuated by 16 dB with coaxial attenuators 2 and 3, and divided into two channels in two-way power divider 4. A digital modulation signal is pre-amplified in amplifier 7, and mixed with the microwave source power in triple-balanced mixer 5, Pacific Microwave Model M3001HA. The modulated source power is combined with the un-modulated source power through a two-way power combiner 6. A line stretcher 12 in the path of the un-modulated source power controls the depth of modulation of the combined output by adjusting for constructive or destructive phase summation. The amplitude-modulated 10 GHz signal is mixed with a signal from a 85-GHz source oscillator 8 in mixer 9 and high-pass filtered in waveguide filter 13 to reject the 75 GHz image band. The resultant, amplitude-modulated 95 GHz signal contains spectral components between 93 and 97 GHz, assuming unfiltered 1.25 Gbps modulation. A rectangular WR-10 wave guide output of the high pass filter is converted to a circular wave guide 14 and fed to a circular horn 15 of 4 inches diameter, where it is transmitted into free space. The horn projects a half-power beam width of 2.2 degrees.

The circuit diagram for the receiver is shown in FIG. 2. The antenna is a circular horn 1 of 6 inches in diameter, fed from a wave guide unit 14R consisting of a circular W-band wave-guide and a circular-to-rectangular wave-guide converter which translates the antenna feed to WR-10 wave-guide which in turn feeds heterodyne receiver module 2R. This module consists of a monolithic millimeter-wave integrated circuit (MMIC) lownoise amplifier spanning 89-99 GHz, a mixer with a two-times frequency multiplier at the LO port, and an IF amplifier covering 5-15 GHz. These receivers are available from suppliers such as Lockheed Martin. The local oscillator 8R is a cavity-tuned Gunn oscillator operating at 42.0 GHz (Spacek Model GQ410K), feeding the mixer in module R2 through a 6 dB attenuator 7. A bias tee 6 at the local oscillator input supplies DC power to receiver module 2R. A voltage regulator circuit using a National Semiconductor LM317 integrated circuit regulator supplies +3.3V through bias tee 6. An IF output of the heterodyne receiver module 2R is filtered at 6-12 GHz using bandpass filter 3 from K&L Microwave. Receiver 4R which is an HP Herotek Model DTM 1180AA diode detector, measures total received power. The voltage output from the diode detector is amplified in two-cascaded microwave amplifiers 5R from MiniCircuits, Model 2FL2000. The baseband output is carried on coax cable to a media converter for conversion to optical fiber, or to a Bit Error-Rate Tester (BERT) 10R.

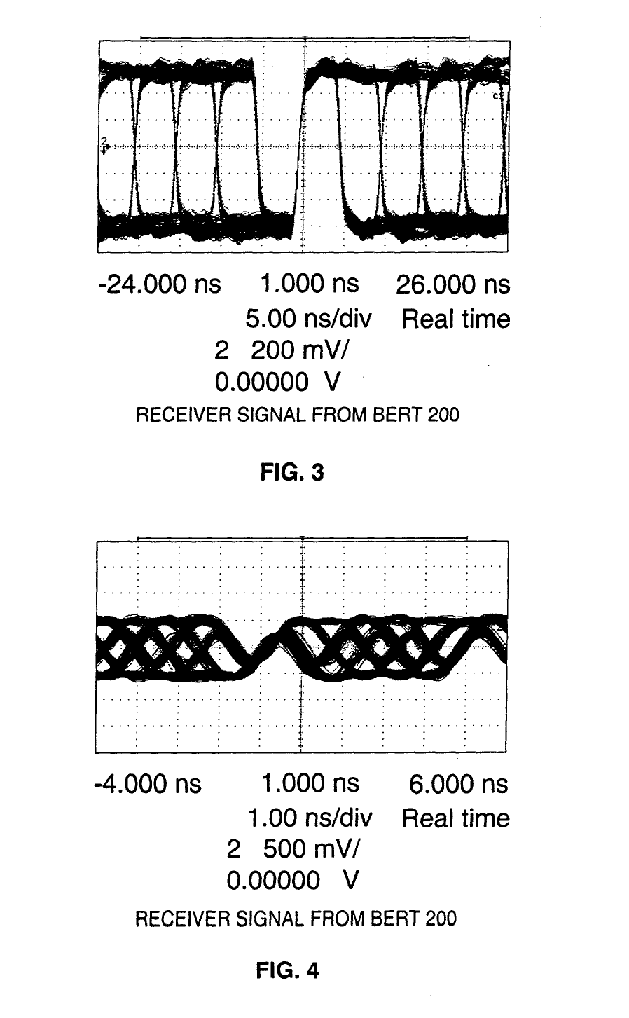

In the laboratory, this embodiment has demonstrated a bit-error rate of less than 10⁻¹² for digital data transmission at 1.25 Gbps. The BERT measurement unit was a Microwave Logic, Model gigaBERT. The oscilloscope signal for digital data received at 200 Mbps is shown in FIG. 3. At 1.25 Gbps, oscilloscope bandwidth limitations lead to the rounded bit edges seen in FIG. 4. Digital levels sustained for more than one bit period comprise lower fundamental frequency components (less than 312 MHz) than those which toggle each period (622 MHz), so the modulation transfer function of the oscilloscope, which falls off above 500 MHz, attenuates them less. These measurement artifacts are not reflected in the bit err(r-rate measurements, which yield <10⁻¹² bit error rate at 1.25 Gbps.

### Transceiver System

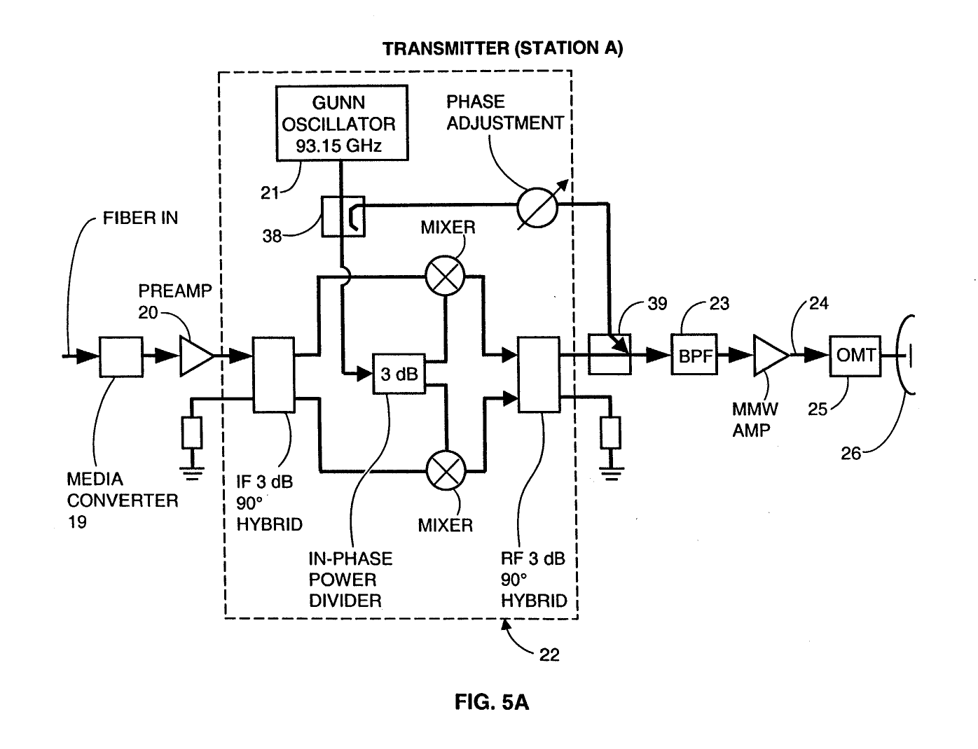

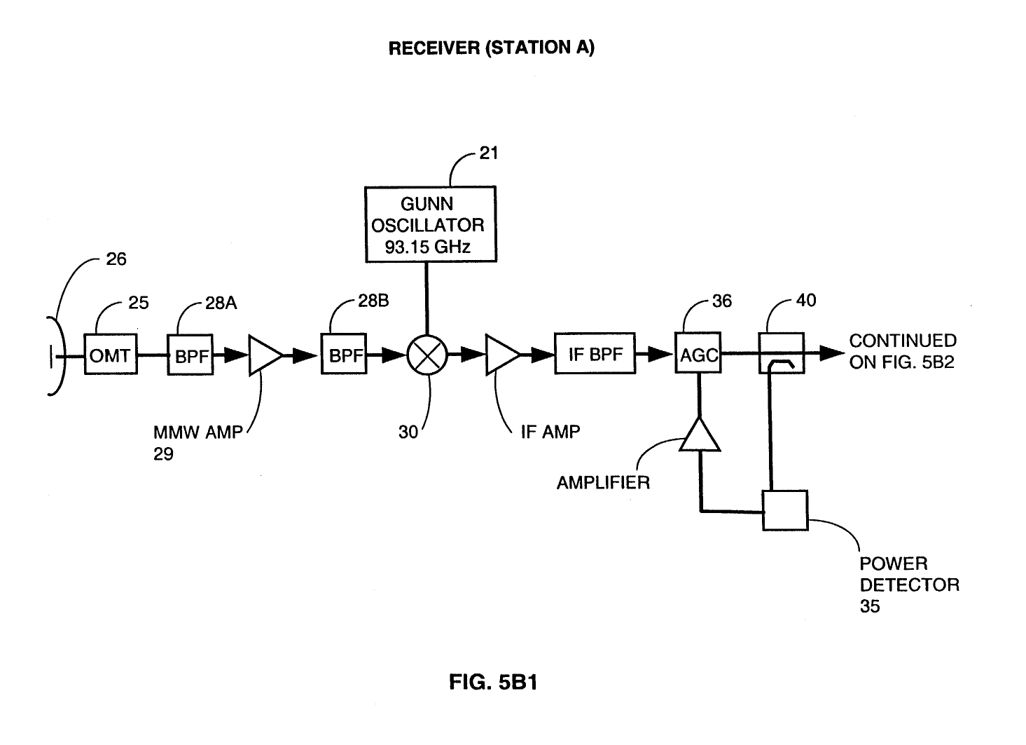

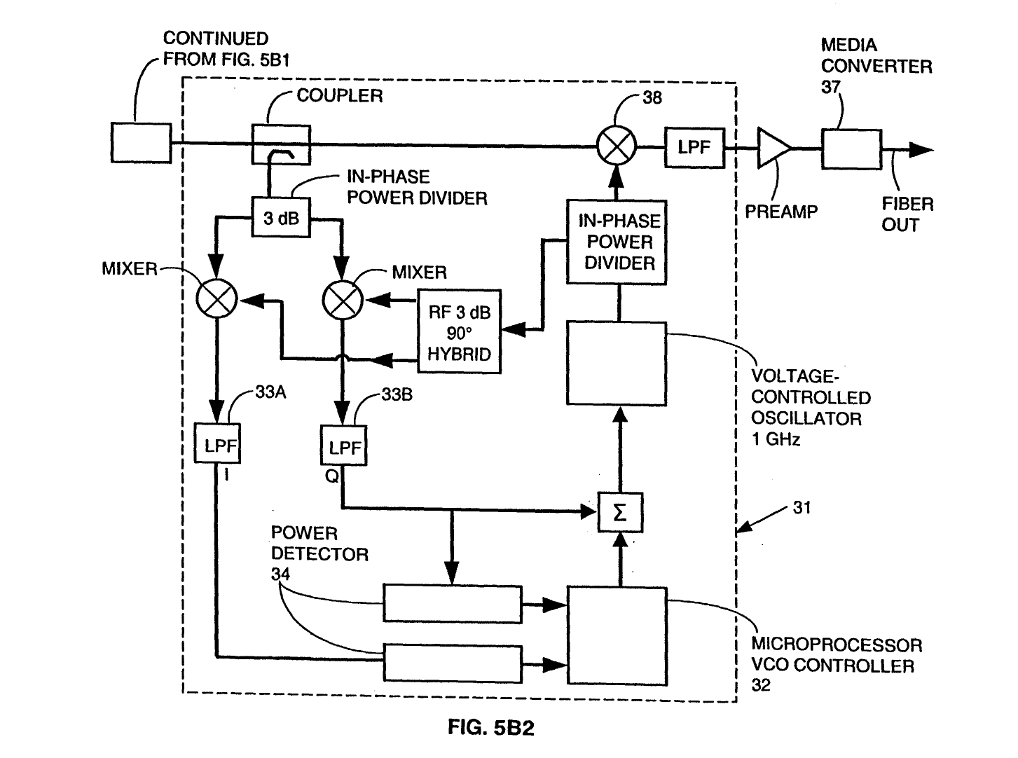

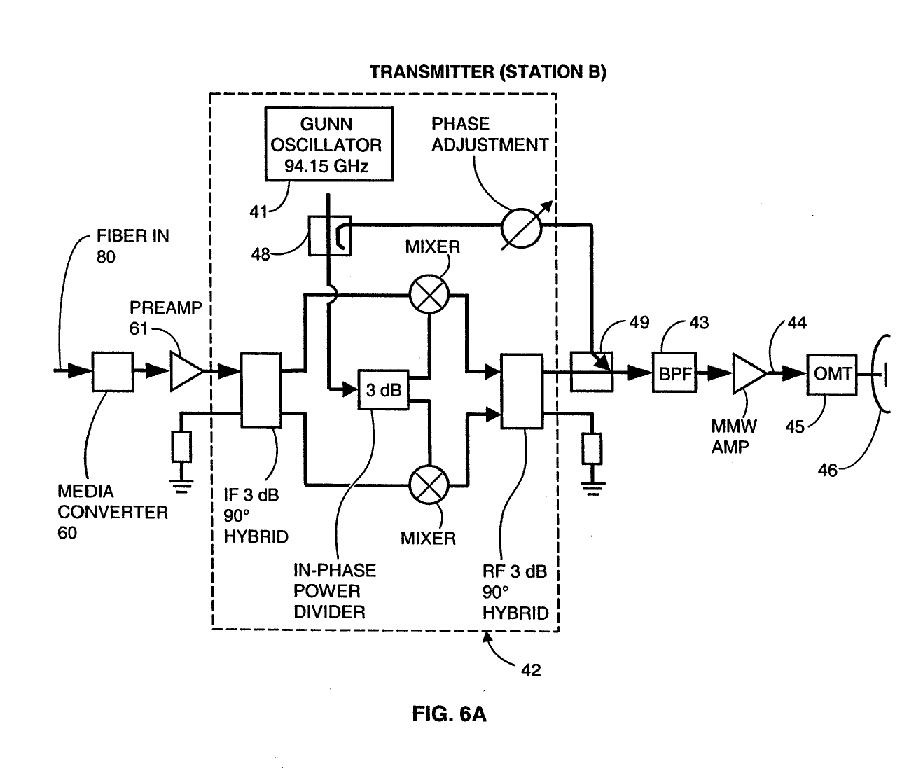

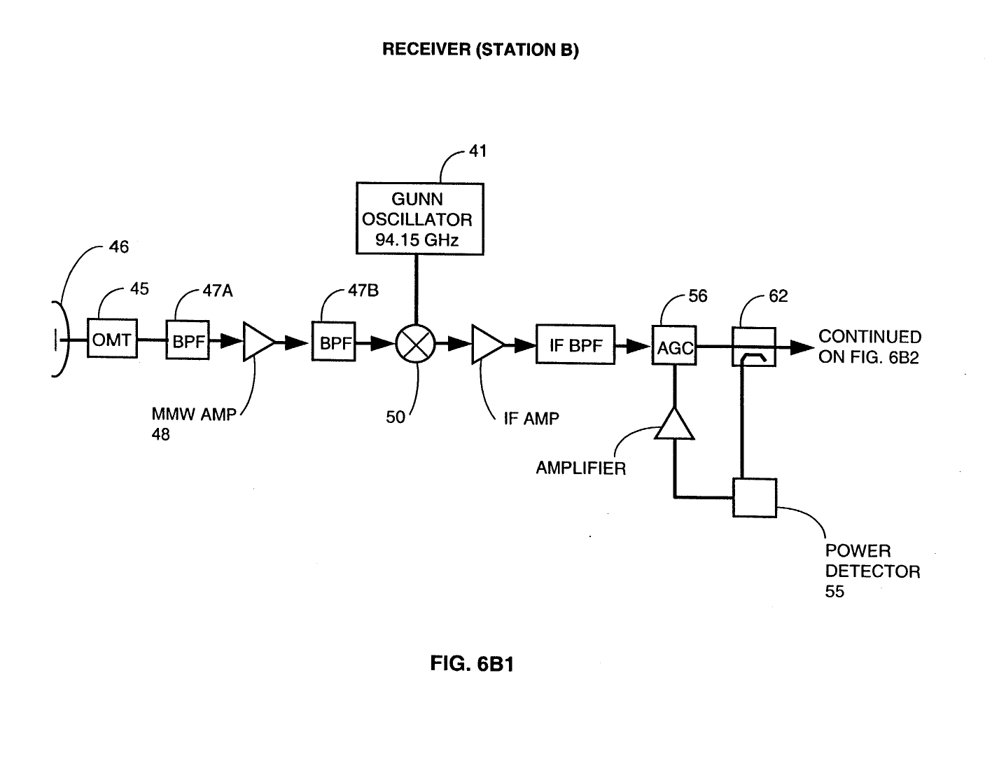

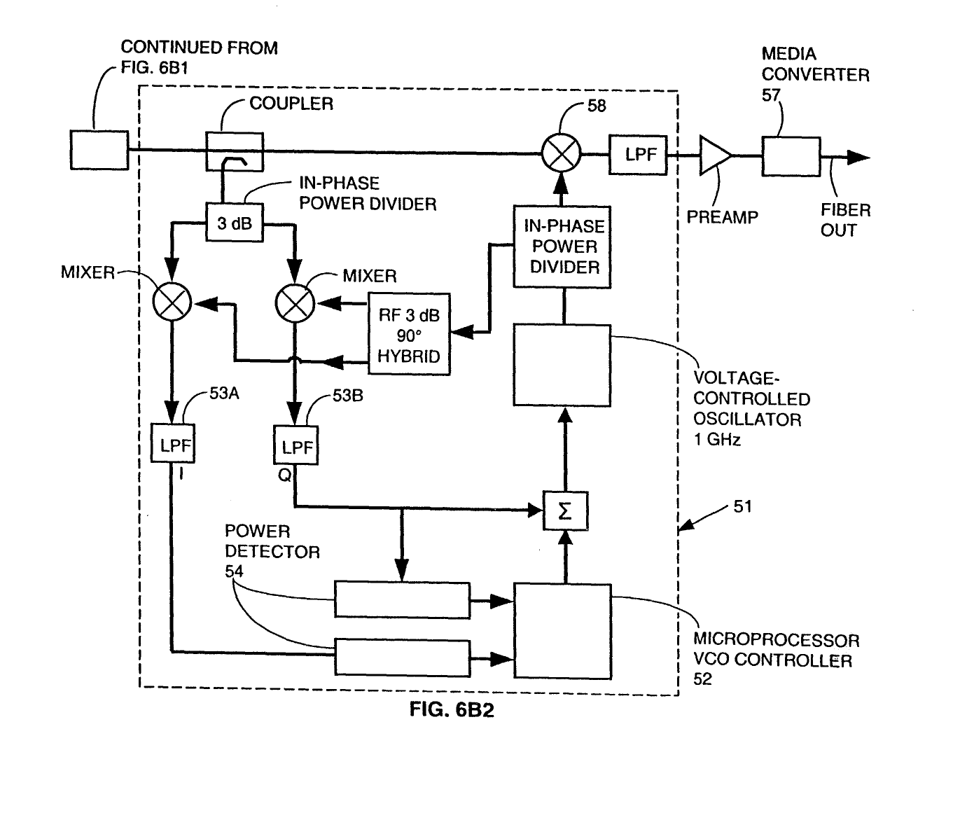

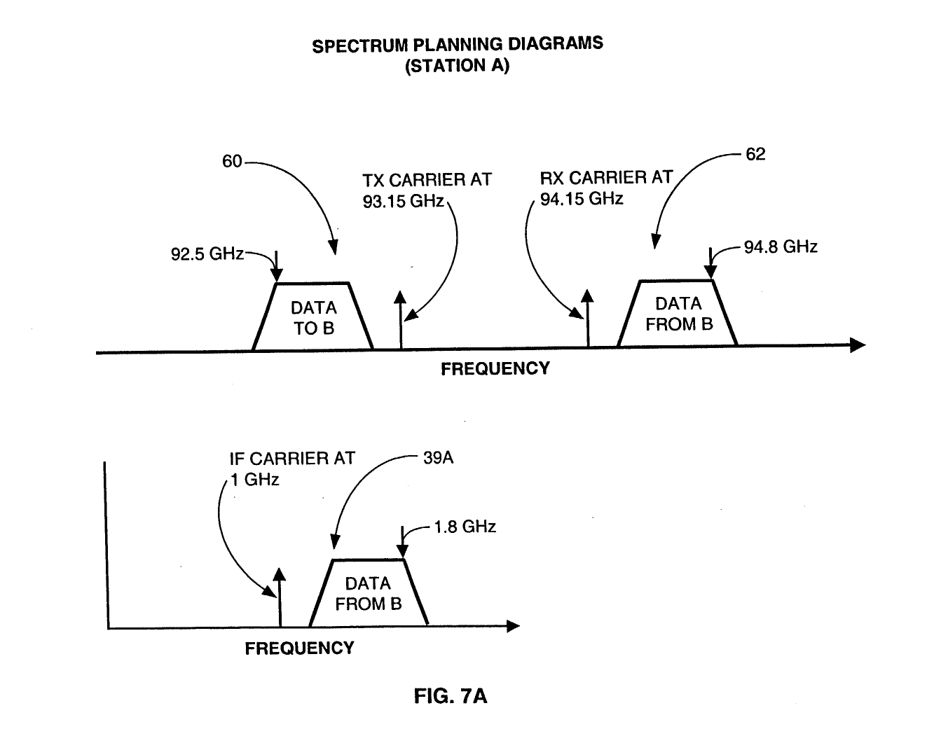

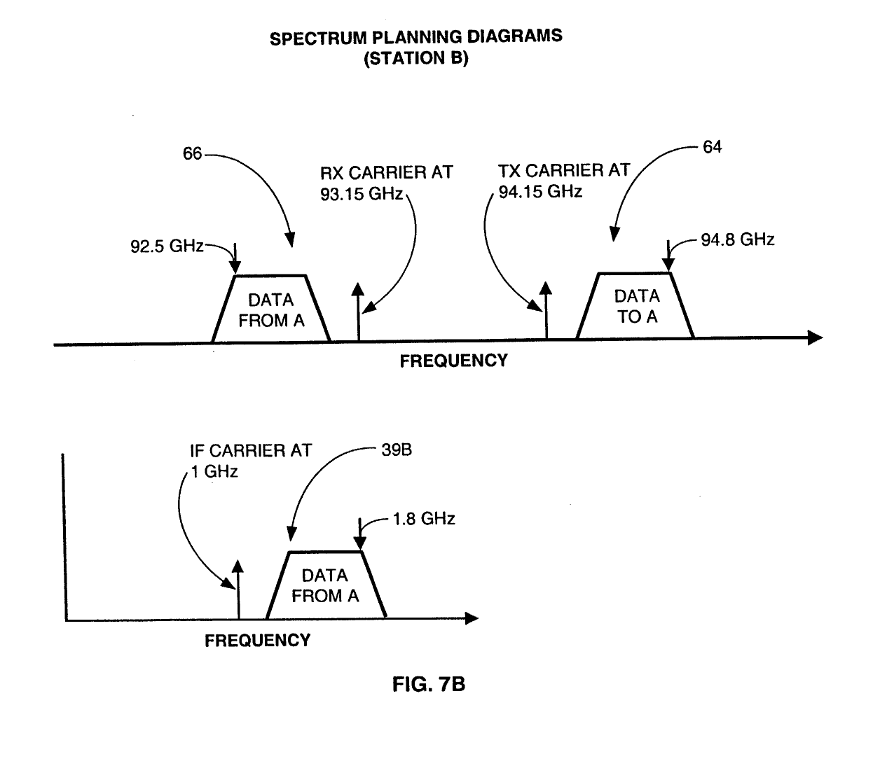

Portions of a preferred embodiment of the present invention is described by reference to FIGS. 5 to 7. The link hardware consists of a millimeter-wave transceiver pair including a pair of millimeter-wave antennas and a microwave transceiver pair including a pair of microwave antennas. The millimeter wave transmitter signal is amplitude modulated and single-sideband filtered, and includes a reduced-level carrier. The receiver includes a heterodyne mixer, phase.-locked intermediate frequency (IF) tuner, and IF power detector. Millimeter-wave transceiver A (FIGS. 5A and 5B) transmits at 92.3-93.2 GHz as shown at 60 in FIG. 7A and receives at 94.1-95.0 GHz as shown at 62, while millimeter-wave transmitter B (FIGS. 6A and 6B) transmits at 94.1-95.0 GHz as shown at 64 in FIG. 7B and receives at 92.3-93.2 GHz as shown at 66.

### Millimeter Wave Transceiver A

As shown in FIG. 5A in millimeter-wave transceiver A, transmit power is generated with a cavity-tuned Gunn diode 21 resonating at 93.15 GHz. This power is amplitude modulated using two balanced mixers in an image reject configuration 22, selecting the lower sideband only. The source 21 is modulated at 1.25 Gbps in conjunction with Gigabit-Ethernet standards. The modulating signal is brought in on optical fiber, converted to an electrical signal in media converter 19 (which in this case is an Agilent model HFCT-5912E) and amplified in preamplifier 20. The amplitude-modulated source is filtered in a 900 MH7-wide passband between 92.3 and 93.2 GHz, using a bandpass filter 23 on microstrip. A portion of the source oscillator signal is picked off with coupler 38 and combined with the lower sideband in power combiner 39, resulting in the transmitted spectrum shown at 60 in FIG. 7A. The combined signal propagates with horizontal polarization through a waveguide 24 to one port of an orthomode transducer 25, and on to a two-foot diameter Cassegrain dish antenna 26, where it is transmitted into free space with horizontal polarization. The receiver unit at Station A as shown on FIGS. 5B1 and 5B2 is fed from the same Cassegrain antenna 26 as is used by the transmitter, at vertical polarization (orthogonal to that of the transmitter), through the other port of the orthomode transducer 25. The received signal is pre-filtered with bandpass filter 28A in a passband from 94.1 to 95.0 GHz, to reject back scattered return from the local transmitter. The filtered signal is then amplified with a monolithic MMW integrated-circuit amplifier 29 on indium phosphide, and filtered again in the same passband with bandpass filter 28B. This twice filtered signal is mixed with the transmitter source oscillator 21 using a heterodyne mixer-downconverter 30, to an IF frequency of 1.00-1.85 GHz, giving the spectrum shown at 39A in FIG. 7A. A portion of the IF signal, picked off with coupler 40, is detected with integrating power detector 35 and fed to an automatic gain control circuit 36. The fixed-level IF output is passed to the next stage as shown in FIG. 5B2. Here a quadrature-based (I/Q) phase-locked synchronous detector circuit 31 is incorporated, locking on the carrier frequency of the remote source oscillator. The loop is controlled with a microprocessor 32 to minimize power in the “Q” channel while verifying power above a set threshold in the “I” channel. Both “I” and “Q” channels are lowpass-filtered at 200 MHz using lowpass filters 33A and 33B, and power is measured in both the “I” and Q channels using square-law diode detectors 34. The baseband mixer 38 output is pre-amplified and fed through a media converter 37, which modulates a laser diode source into a fiber-optic coupler for transition to optical fiber transmission media.

### Transceiver B

As shown in FIG. 6A in millimeter-wave tranceiver B, transmit power is generated with a cavity-tuned Gunn diode 41 resonating at 94.15 GHz. This power is amplitude modulated using two balanced mixers in an image reject configuration 42, selecting the upper sideband only. The source 41 is modulated at 1.25 Gbps in conjunction with Gigabit-Ethernet standards. The modulating signal is brought in on optical fiber as shown at 80, converted to an electrical signal in media converter 60, and amplified in preamplifier 61. The amplitude-modulated source is filtered in a 900 MHz-wide passband between 94.1 and 95.0 GHz, using a bandpass filter 43 on microstrip. A portion of the source oscillator signal is picked off with coupler 48 and combined with the higher sideband in power combiner 49, resulting in the transmitted spectrum shown at 64 in FIG. 7B. The combined signal propagates with vertical polarization through a waveguide 44 to one port of an orthomode transducer 45, and on to a Cassegrain dish antenna 46, where it is transmitted into free space with vertical polarization. The receiver is fed from the same Cassegrain antenna 46 as the transmitter, at horizontal polarization (orthogonal to that of the transmitter), through the other port of the orthomode transducer 45. The received signal is filtered with bandpass filter 47A in a passband from 92.3 to 93.2 GHz, to reject backscattered return from the local transmitter. The filtered signal is then amplified with a monolithic MMW integrated-circuit amplifier on indium phosphide 48, and filtered again in the same passband with bandpass filter 47B. This twice filtered signal is mixed with the transmitter source oscillator 41 using a heterodyne mixer-downconverter 50, to an IF frequency of 1.00-1.85 GHz, giving the spectrum shown at 39B in FIG. 7B. A portion of the IF signal, picked off with coupler 62, is detected with integrating power detector 55 and fed to an automatic gain control circuit 56. The fixed-level IF output is passed to the next stage as shown on FIG. 6B2. Here a quadrature-based (I/Q) phase-locked synchronous detector circuit 51 is incorporated, locking on the carrier frequency of the remote source oscillator. The loop is controlled with a microprocessor 52 to minimize power in the “Q” channel while verifying power above a set threshold in the “I” channel. Both “I” and “Q” channels are lowpass-filtered at 200 MHz using a bandpass filters 53A and 53B, and power is measured in each channel using a square-law diode detector 54. The baseband mixer 58 output is pre-amplified and fed through a media converter 57, which modulates a laser diode source into a fiber-optic coupler for transition to optical fiber transmission media.

### Very Narrow Beam Width

A dish antenna of two-foot diameter projects a half-power beam width of about 0.36 degrees at 94 GHz. The full-power beamwidth (to first nulls in antenna pattern) is narrower than 0.9 degrees. This suggests that up to 400 independent beams could be projected azimuthally around an equator from a single transmitter location, without mutual interference, from an array of 2-foot dishes. At a distance of ten miles, two receivers placed 800 feet apart can receive independent data channels from the same transmitter location. Conversely, two receivers in a single location can discriminate independent data channels from two transmitters ten miles away, even when the transmitters are as close as 800 feet apart. Larger dishes can be used for even more directivity.

### Beam Steering

In the parent to this case Ser. No. 09/847,692, the Applicants disclosed:

“Phased-array beam combining from several ports in the flat-panel phased array could steer the beam over many antenna beam widths without mechanically rotating the antenna itself. Sum-and-difference phase combining in a mono-pulse receiver configuration locates and locks on the proper “pipe.” In a Cassegrain antenna, a rotating, slightly unbalanced secondary (“conical scan”) could mechanically steer the beam without moving the large primary dish. For prime focus and offset parabolas, a multi-aperture (e.g. quad-cell) floating focus could be used with a selectable switching array. In these dish architectures, beam tracking is based upon maximizing signal power into the receiver. In all cases, the common aperture for the receiver and transmitter ensures that the transmitter, as well as the receiver, is correctly pointed.”

This Continuation-In-Part Application elaborates on this technique for keeping these pencil beams aligned and also discloses a less expensive flat panel tracking antenna for doing this job.

### Cassegrain Monopulse Tracking Antenna

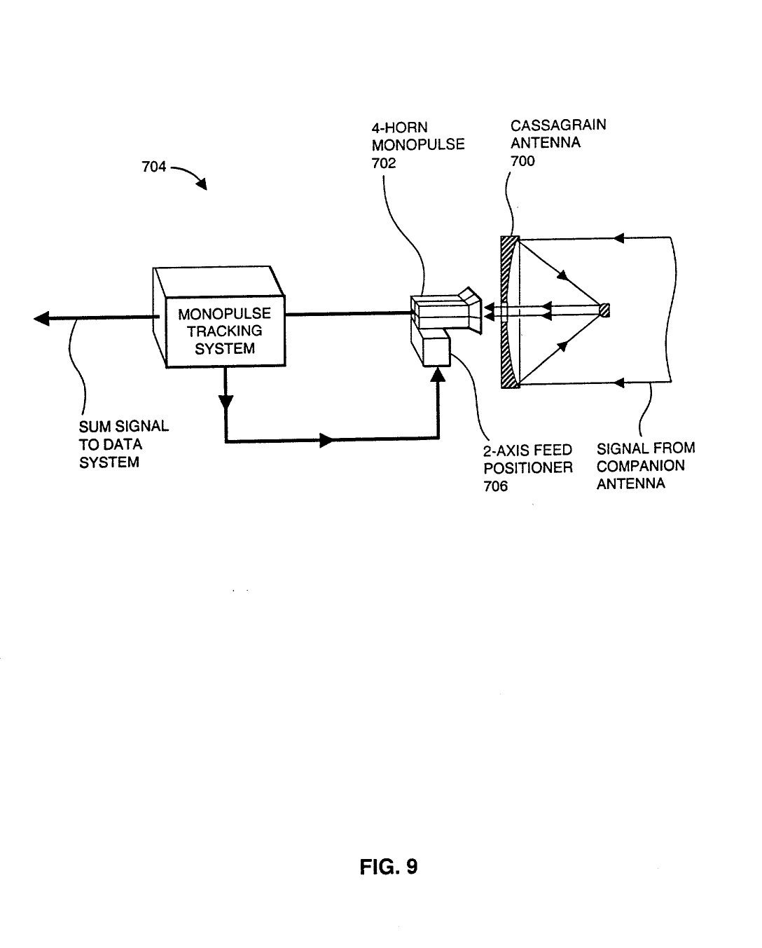

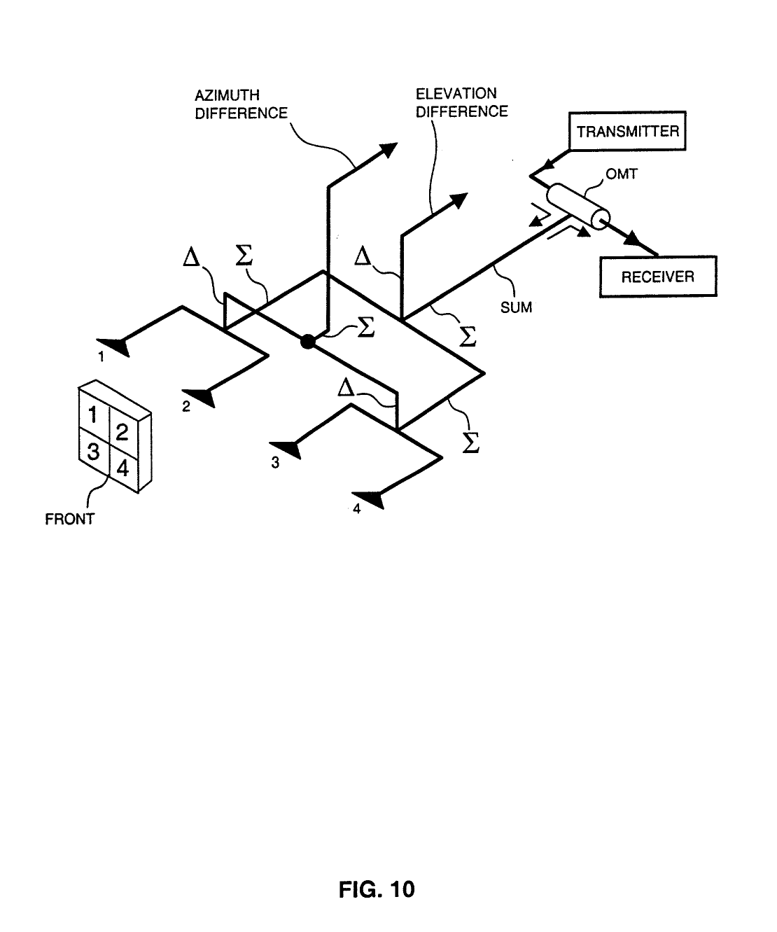

In a preferred embodiment to provide end-user high-gain the antenna is a tracking Cassegrain antenna using monopulse tracking (or more specifically amplitude comparison monopulse tracking) as shown in FIGS. 9, 10 and 11. FIG. 9 shows the principal elements of the antenna system. Cassegrain antenna 700 is utilized with a four horn feed 702 which is a part of a monopulse tracking system 704 similar to monopulse tracking systems used for radar applications. Whereas radar systems need to track over large angular spaces, a fixed wireless link needs relatively small angular displacements, typically less than 1 degree. Therefore, the preferred physical method of tracking in the instant invention is to move the feed horns rather than move the Cassagrain antenna. The antenna system comprises a two-axis positioner 706 for the four horn feed which adjusts the four-horn feed in azimuth and elevation based on monopulse information as described below in order to keep it at all times pointed directly at a companion antenna with which it is communicating. As described below, communication (both transmit and receive) is through a four-horn sum signal that is provided to the four-horn feed 702. FIG. 10 shows how signals are applied to and received from the four horns 702 to both communicate and to point the antenna beam. The positions of each of the four horns are shown at 708. The figure shows how the sum signals and the difference signals are extracted from the wave-guides feeding the horns. The figure also shows how an orthomode transceiver is used to both transmit and receive through the sum signal from the wave-guides.

FIG. 10 details the comparator circuitry that performs the addition and subtraction of the feed horn outputs to obtain the monopulse sum and difference signals. It is illustrated with hybrid-T or magic-T waveguide devices that are well known in the art. These are four-port devices which, in basic form, have the inputs and outputs located at right angles to each other. However, magic T's have been developed in convenient “folded” configurations for very compact comparator packages.

The subtractor outputs are called difference signals, which are zero when the companion antenna is on axis, in creasing in amplitude with increasing displacement of the companion antenna from the receiving antenna's axis. The difference signals also change 180 degrees in phase from one side of center to the other. The sum of all four horn outputs provides a reference signal to allow angle-tracking sensitivity even though the companion antenna signal varies over a large dynamic range due weather variations. AGC (automatic gain control) is necessary to keep the gain of the angle-tracking loops constant for stable automatic angle tracking.

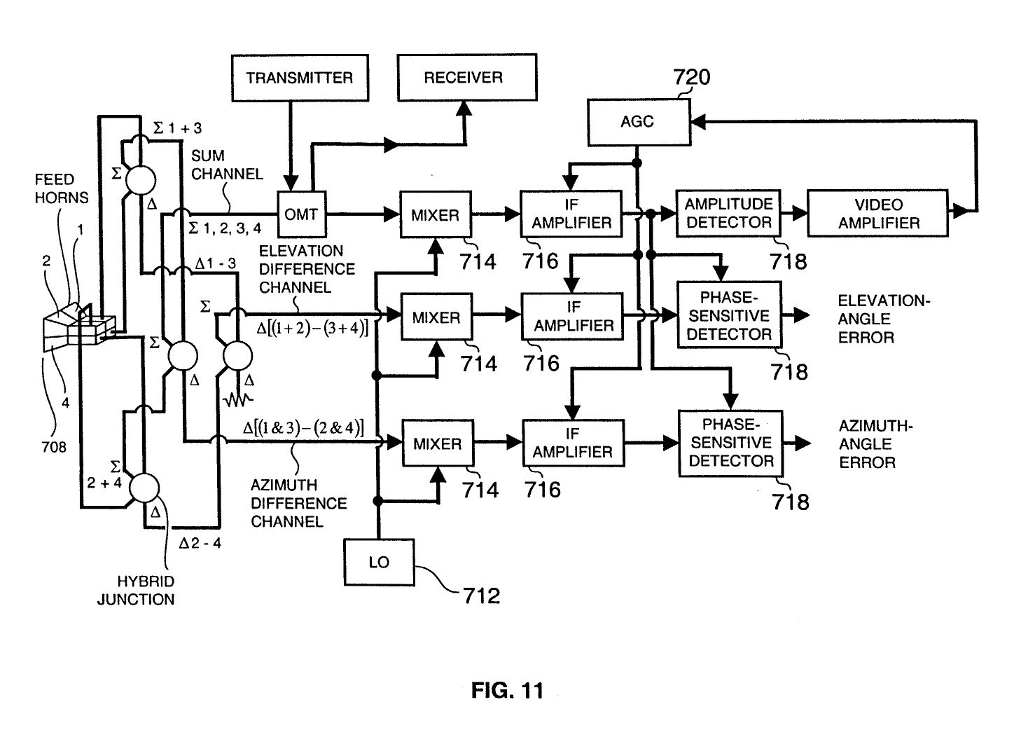

FIG. 11 provides a more detailed layout of the monopulse tracking system. The system uses single local oscillator 712, mixers 714, amplifiers 716, detectors 718 and automatic gain control 720 which is typical in monopulse radar tracking. The difference is the transmit signal is a digital commnunication signal in the range of about 92.3 to 93.2 GHz and the receive signal from its companion antenna is in the range of about 94.1 to 95.0 GHz as described above. Transmit and receive signals of its companion antenna are the reverse frequencies. The sum signal, elevation difference signal, and azimuth difference signal are each converted to intermediate frequency (IF), using a common local oscillator to maintain relative phase at IF. A video unit is used to generate a voltage proportional to the magnitude of the sum signal for all three IF amplifier channels.

The sum signal at the IF output also provides a reference signal to phase detectors which derive angle-tracking-error voltages from the difference signal. The phase detectors are essentially dot-product devices producing an output voltage:

e=|Δ|/|Σ| cos θ

where

e=angle-error-detector output voltage,

|Σ|=magnitude of the sum signal,

|Δ|=magnitude of the difference signal, and

θ=phase angle between the sum and difference signals.

The angle-error-detector output voltage is bipolar video. It is a video signal with an amplitude proportional to the angle error and whose polarity (positive or negative) corresponds to the direction of the error. This video signal is typically processed by a circuit that averages it. With moderate low-pass filtering, this gives a dc error voltage output employed by the servo amplifiers to correct the antenna feed position. The reader should refer to FIGS. 5A to 6B2 and the accompanying text for further details of the communication equipment for this system.

As is true for the planar phased array, when appropriate time delay is added to null out differential amplitude in the four receiver channels, a transmitter propagating source power back to the antenna through the same paths and delays is guaranteed to radiate out precisely toward the remote transceiver.

### Other Tracking Dish Antennas

Other tracking techniques for keeping the pencil beam aligned can be used. One alternative is the conical scan technique that is another well known technique used for radar scanning. A good explanation of this scanning technique is provided in Introduction to Radar Systems by Merriss I Skolnik, McGraw-Hill, Pages 155-159. Those techniques for scanning the radar beam can be adapted to communication using the same techniques discussed above for the monopulse approach. Another approach is the sequential lobing also described in the above reference. It too could be adapted to keep the communication antennas aligned using the concepts described above.

In addition to the Cassegrain, other dish-type antennas could be used for tracking with the monopulse technique as described above. And these other types of antennas could also be used with the other scanning techniques. Some of these other antenna types are discussed below under the heading “Narrow Beam Width Antennas”.

### Backup Microwave Transceiver Pair

During severe weather conditions data transmission quality will deteriorate at millimeter wave frequencies. Therefore, in preferred embodiments of the present invention a backup communication link is provided which automatically goes into action whenever a predetermined drop-off in quality transmission is detected. A preferred backup system is a microwave transceiver pair operating in the 10.7-11.7 GHz band. This frequency band is already allocated by the FCC for fixed point-to-point operation. FCC service rules parcel the band into channels of 40-MHz maximum bandwidth, limiting the maximum data rate for digital transmissions to 45 Mbps full duplex. Transceivers offering this data rate within this band are available off-the-shelf from vendors such as Western Multiplex Corporation (Models Lynx DS-3, Tsunami 100BaseT), and DMC Stratex Networks (Model DXR700 and Altium 155). The digital radios are licensed under FCC Part 101 regulations. The microwave antennas are Cassegrain dish antennas of 24-inch diameter. Al this diameter, the half-power beamwidth of the dish antenna is 3.0 degrees, and the full-power beamwidth is 7.4 degrees, so the risk of interference is higher than for MMW antennas. To compensate this, the FCC allocates twelve separate transmit and twelve separate receive channel, for spectrum coordination within the 10.7-11.7 GHz band. Sensing of a millimeter wave link failure and switching to redundant microwave channel is an existing automated feature of the network routing switching hardware available off-the-shelf from vendors such as Cisco, Foundry Networks and Juniper Networks.

### Narrow Beam Width Antennas

The narrow antenna beam widths afforded at millimeter-wave frequencies allow for geographical portioning of the airwaves, which is impossible at lower frequencies. This fact eliminates the need for band parceling (frequency sharing), and so enables wireless communications over a much larger bandwidth, and thus at much higher data rates, than were ever previously possible at lower RF frequencies.

The ability to manufacture and deploy antennas with beam widths narrow enough to ensure non-interference, requires mechanical tolerances, pointing accuracies, and electronic beam steering/tracking capabilities, which exceed the capabilities of the prior art in communications antennas. A preferred antenna for long-range communication at frequencies above 70 GHz has gain in excess of 50 dB, 100 times higher than direct-broadcast satellite dishes for the home, and 30 times higher than high-resolution weather radar antennas on aircraft. However, where interference is not a potential problem, antennas with dB gains of 40 to 45 may be preferred.

Most antennas used for high-gain applications utilize a large parabolic primary collector in one of a variety of geometries. The prime-focus antenna places the receiver directly at the focus of the parabola. The Cassegrain antenna places a convex hyperboloidal secondary reflector in front of the focus to reflect the focus back through an aperture in the primary to allow mounting the receiver behind the dish. (This is convenient since the dish is typically supported from behind as well.) The Gregorian antenna is similar to the Cassegrain antenna, except that the secondary mirror is a concave ellipsoid placed in back of the parabola's focus. An offset parabola rotates the focus away from the center of the dish for less aperture blockage and improved mounting geometry. Cassegrain, prime focus, and offset parabolic antennas are the preferred dish geometries for the MMW communication system.

A preferred primary dish reflector is a conductive parabola. The preferred surface tolerance on the dish is about 15 thousandths of an inch (15 mils) for applications below 40 GHz, but closer to 5 mils for use at 94 GHz. Typical hydroformed aluminum dishes give 15-mil surface tolerances, although double-skinned laminates (using two aluminum layers surrounding a spacer layer) could improve this to 5 mils. The secondary reflector in the Cassegrainian geometry is a small, machined aluminum “lollipop” which can be made to 1-mil tolerance without difficulty. Mounts for secondary reflectors and receiver waveguide horns preferably comprise mechanical fine-tuning adjustment for in-situ alignment on an antenna test range.

### Flat-Panel Antenna

Another preferred antenna for long-range MMW communication is a flat-panel slot array antenna such as that described by one of the present inventors and others in U.S. Pat. No. 6,037,908, issued Mar. 14, 2000which is hereby incorporated herein by reference. That antenna is a planar phased array antenna propagating a traveling wave through the radiating aperture in a transverse electromagnetic (TEM) mode. A communications antenna comprises a variant of that antenna incorporating the planar phased array, but eliminating the frequency-scanning characteristics of the antenna in the prior art by adding a hybrid traveling-wave/corporate feed. Flat plates holding a 5-mil surface tolerance are substantially cheaper and easier to fabricate than parabolic surfaces. Planar slot arrays can utilize circuit-board processing techniques (e.g. photolithography), which are affordable and inherently very precise, rather than using expensive high-precision machining.

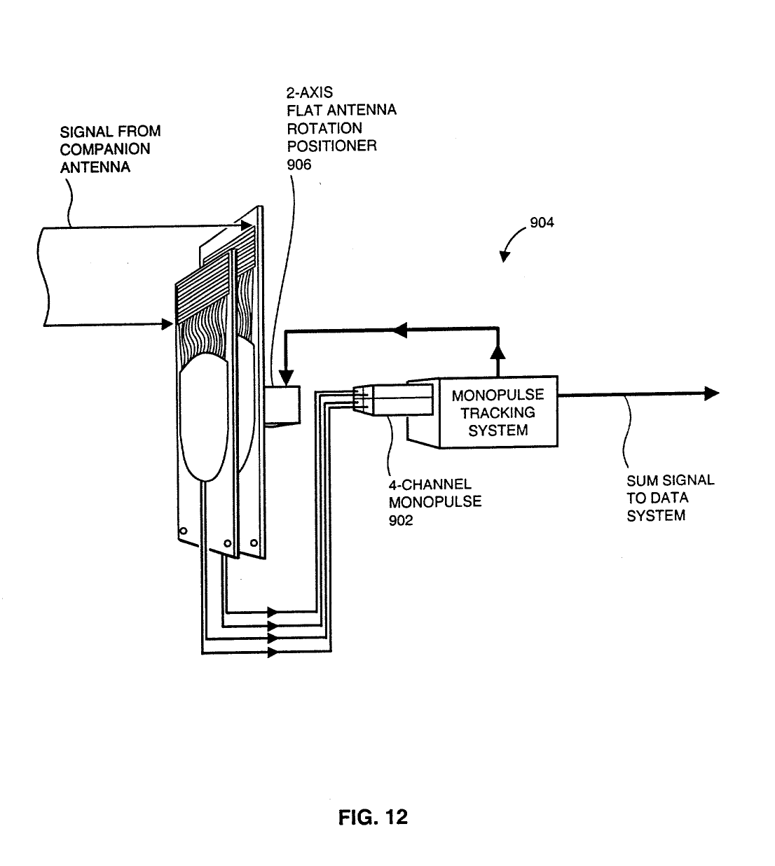

FIG. 12 schematically shows the principal elements of a flat-panel antenna system. Flat-panel antenna 900 is utilized with a four horn feed 902 that is a part of a monopulse tracking system 904 (or more specifically an amplitude comparison monopulse tracking system) similar to monopulse tracking systems used for radar. Whereas radar systems need to track over large angular spaces, a fixed wireless link needs relatively small angular displacements, typically less than 1 degree. Therefore, the preferred physical method of tracking in the instant flat-panel antenna invention is to slightly rotate the flat-panel antenna. The flat-panel antenna system comprises a two-axis rotation positioner 906 for the flat-panel antenna which adjusts the flat-panel antenna in azimuth and elevation based on monopulse information as described below in order to keep it at all times pointed directly al a companion antenna with which it is communicating. As described below, communication (both transmit and receive) is through a four-channel sum signal that is provided to the four-channel feed 902.

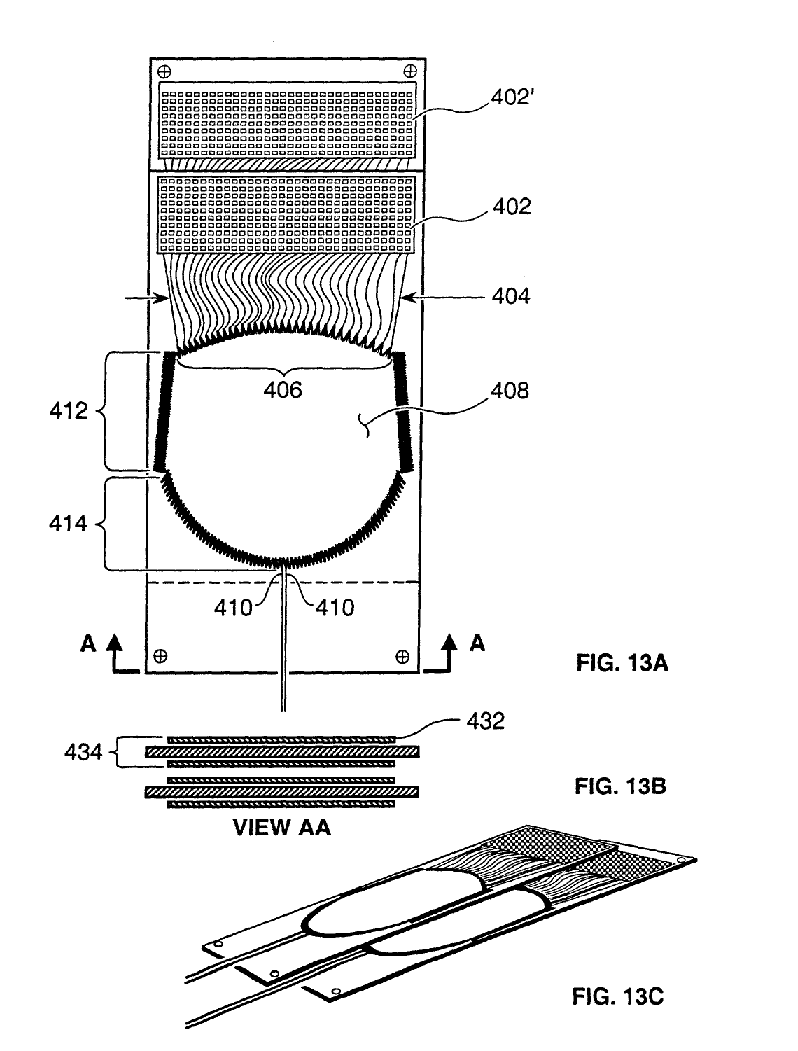

FIGS. 13A, 13B and 13C show front and bottom and isometric (exploded) views, respectively, of the flat-panel antenna. FIG. 13A shows a flat-panel slot array antenna 402 such as described in U.S. Pat. No. 6,037,908, which is fed by bootlace lines 404, which are in turn fed by lens-antenna horns 406 of lens 408 which are ultimately fed by focal-plane horns 410. Anechoic horns 412 and focal plane horns 414 are covered by absorptive material (e.g. Ecosorb, available from Millimeter Wave Technology, Inc., Passaic, New Jersey) which effectively absorbs any electromagnetic wave energy that is propagating down the anechoic horns 412 and focal plane horns 414 and thereby essentially eliminating any reflected wave from negatively affecting the performance of lens 408.

FIG. 13B shows that this antenna is a laminate of two similar flat-panel slot array antennas, one offset vertically relative to the other. Each of the two similar flat-panel slot array antennas comprises two conductor layers separated by a dielectric layer that is slightly less than a half of a wavelength thick (where wavelength is defined within the dielectric). For example, a flat-panel slot array antenna operating in the mid-90 GHz range, with a dielectric constant of 2.2 (made for example of low-loss polyethylene), would have a thickness Df about 0.030 inches. The width of the flat-panel slot array antenna 402 is about 24 inches and its height is about 6 inches. Assuming these fabrication and frequency parameters, a beam about 0.3 degrees wide and about 1.2 degrees tall will be produces by flat-panel slot array antenna 402.

In accordance with U.S. Pat. No. 6,037,908, conductor of the top layer 432 is a copper radiating cover plate comprised of a copper foil 0.2 mm thick, 24 inches wide and 6 inches long. Cut in it using a lithography process are slots having dimensions of about 0.1 mm by 1.2 mm located on 1.8 mm centers in the 6 inch direction and 1.5 mm centers in the 24 inch direction with the long slot dimension in the 24-inch (i.e. wide) direction. Lens 408 is created by etching away part of the conductor of the top layer 432 of the conductor/dielectric/conductor sandwich structure 434 with the pattern as shown in FIG. 13A. A focused signal then emerges at one of two focal-plane horns 410. Focal-plane horns 410 are, for example, horn features etched on the top conducting layer 432 of the conductor/dielectric/conductor sandwich structure 434. Similarly, bootlace lines 404 are created by etching away part of the conductor of the top layer 432 of the conductor/dielectric/conductor sandwich structure 434 with the pattern as shown in FIG. 13A. Bootlace lines 404 may be microstrip structures as shown, or alternatively, stripeline structures which are not shown.

Flat-panel slot sub-array 908 is constructed to create a beam that is pointed at a slightly different elevation angle than flat-panel slot sub-array 910. The pointing difference is necessary to ensure proper operation of the monopulse tracking technique. The pointing difference, which is of the order of 1 beam width of a flat-panel slot sub-array (or more specifically any value from about ⅓ to 2 beam widths), can be accomplished in at least two different ways. The first way to create the slightly different elevation angle is to rotate the structural support for one sub-array relative to the other. The second way to create the slightly different elevation angle is to very slightly change the vertical spacing between the slots for one sub-array relative to the other. For example, for an antenna operating at 93 GHz with 6-inch high sub-arrays, a sub-array beam width is about 1 degree. Thus one sub-array must be rotated relative to the other by 0.3 degree to 2 degrees or, in the alternative, the vertical spacing between the slots for one sub-array must be very slightly (for example, roughly 1%) changed relative to the other.

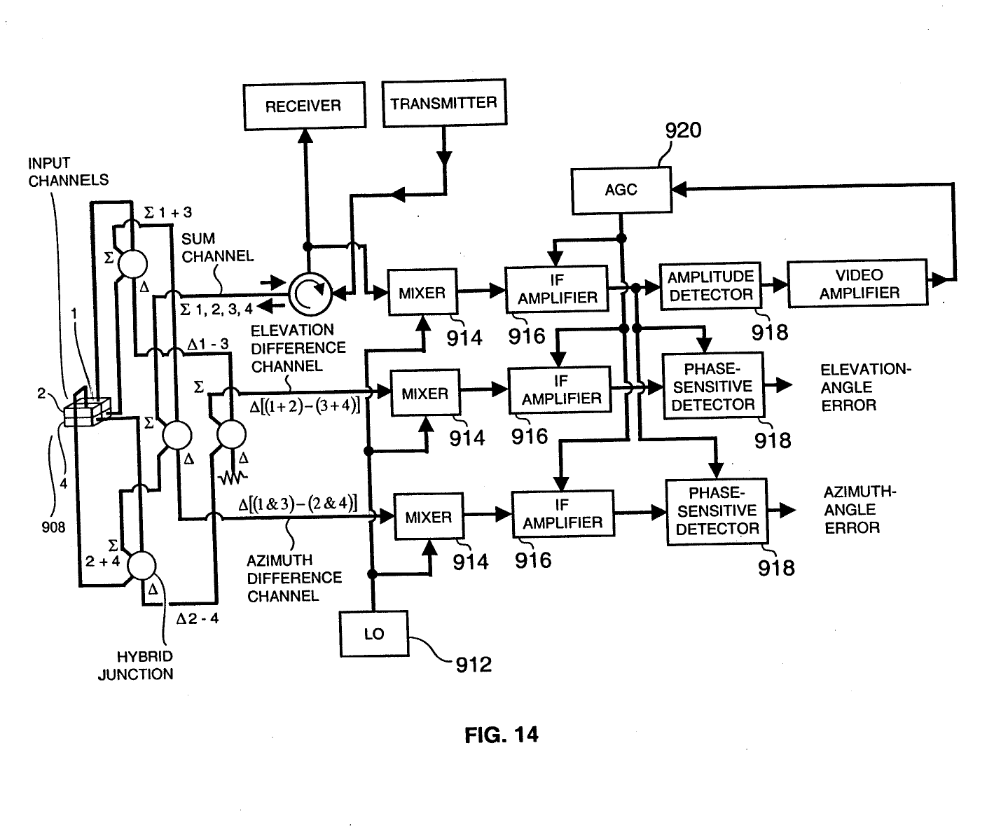

FIG. 14 provides a more detailed layout of the flat-panel antenna monopulse tracking system. The system uses a single local oscillator 912, mixers 914, amplifiers 916, detectors 918 and automatic gain control 920 which is typical in monopulse radar tracking. The difference is the transmit signal is a digital communication signal in the range of about 92.3 to 93.2 GHz and the receive signal from its companion antenna is in the range of about 94.1 to 95.0 GHz as described above. The transmit and receive signals of its companion antenna are the reverse frequencies. The reader should refer to FIGS. 5A to 6B2 and the accompanying text for further details of the communication equipment for this system. It is important also to note that while the monopulse dish system described in FIGS. 9, 1C, and 11 uses an OMT to separate outgoing and return signals, the flat-panel preferred embodiment depicted in FIG. 14 uses a circulator to separate the transmitted and received signals. The reason for this difference is that the flat-panel antenna and associated focusing lens of FIG. 13 operate with a single polarization orientation only. Hence the use of the OMT technique, which utilizes two different polarizations for the separation process, is not appropriate for the flat-panel antenna of this preferred embodiment.

### Typical Installation

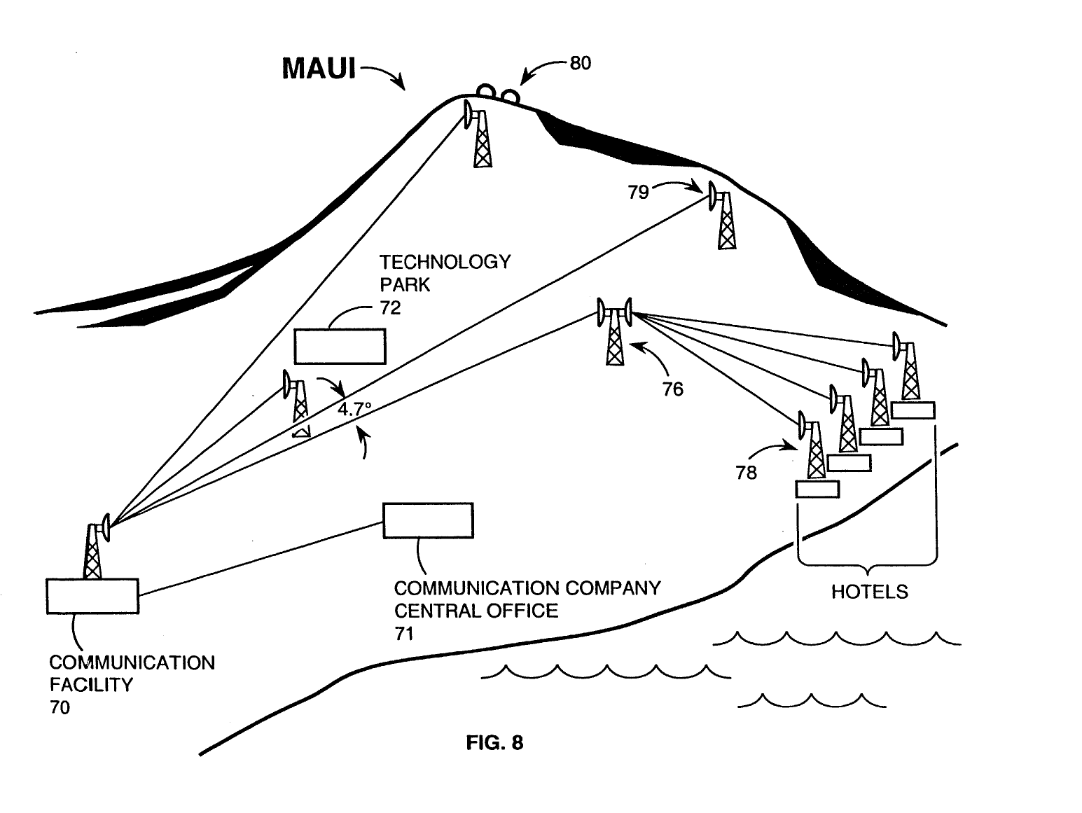

FIG. 8 is a map layout of a proposed application of the present invention. This map depicts a sparsely populated section of the island, Maui in Hawaii. Shown are communication facility 70 which is connected to a major communication trunk line from a communication company's central office 71, a technology park 72 located about 2 miles from facility 70, a relay station 76 located about 6 miles from facility 70 and four large ocean-front hotels 78 located about 3 miles from relay station 76. Also shown is a mountaintop observatory 80 located 13 miles from facility 70 and a radio antenna tower 79 located 10 miles from facility 70. As indicated in FIG. 8, the angular separation between the radio antenna and the relay station is only 4.7 degrees. Four type-A transceiver units are positioned at facility 70, each comprising a transmitter and receiver unit as described in FIGS. 5A and 5B. These units are directed at corresponding type-B transceiver units positioned at the technology park, the relay station, the observatory, and the radio tower. Millimeter wave transceiver units with back-up microwave units as described above are also located at the hotels and are in communication with corresponding units at the relay station. In a preferred embodiment the 1.25 GHz spectrum is divided among the four hotels so that only one link needs to be provided between facility 70 and relay station 76. This system can be installed and operating within a period of about one month and providing the most modern communication links to these relatively isolated facilities. The cost of the system is a very small fraction of the cost of providing fiber optic links offering similar service.

The microwave backup links operate at approximately eight times lower frequency (8 times longer wavelength) than the millimeter wave link. Thus, at a given size, the microwave antennas have broader beam widths than the millimeter-wave antennas, again wider by about 8 times. A typical beam width from a 2-foot antenna is about 7.5 degrees. This angle is wider than the angular separation of four service customers (hotels) from the relay tower and it is wider than the angular separation of the beam between the relay station and the radio antenna. Specifically, the minimum angular separation between hotels from the relay station is 1.9 degrees. The angular separation between receivers at radio antenna tower 79 and relay station 76 is 4.7 degrees as seen from a transmitter at facility 70. Thus, these microwave beams cannot be separated spatially; however, the FCC Part 101 licensing rules mandate the use of twelve separate transmit and twelve separate receive channels within the microwave 10.7 to 11.7 GHz band, so these microwave beams can be separated spectrally. Thus, the FCC sponsored frequency coordination between the links to individual hotels and between the links to the relay station and the radio antenna will guarantee non-interference, but at a much reduced data rate. The FCC has appointed a Band Manager, who oversees the combined spatial and frequency coordination during the licensing process.

### Other Embodiments

Any millimeter-wave carrier frequency consistent with U.S. Federal Communications Commission spectrum allocations and service rules, including MMW bands currently allocated for fixed point-to-point services at 57-64 GHz, 71-76 GHz, 81-86 GHz, and 92-100 GHz, can be utilized in the practice of this invention. Likewise any of the several currently-allocated microwave bands, including 5.2-5.9 GHz, 5.9-6.9 GHz, 10.7-11.7 GHz, 17.7-19.7 GHz, and 21.2-23.6 GHz can be utilized for the backup link. The modulation bandwidth of both the MMW and microwave channels can be increased, limited again only by FCC spectrum allocations. Also, any flat, conformal, or shaped antenna capable of transmitting the modulated carrier over the link distance in a means consistent with FCC emissions regulations can be used. Horns, prime focus and offset parabolic dishes, and planar slot arrays are all included.

Transmit power may be generated with a Gunn diode source, an injection-locked amplifier or a MMW tube source resonating at the chosen carrier frequency or at any sub-harmonic of that frequency. Source power can be amplitude, frequency or phase modulated using a PIN switch, a mixer or a biphase or continuous phase modulator. Modulation can take the form of simple bi-state AM modulation, or can involve more than two symbol states; e.g. using quantized amplitude modulation (QAM). Double-sideband (DSB), single-sideband (SSB) or vestigial sideband (VSB) techniques can be used to pass, suppress or reduce one AM sideband and thereby affect bandwidth efficiency. Phase or frequency modulation schemes can also be used, including simple FM, bi-phase, or quadrature phase-shift keying (QPSK). Transmission with a full or suppressed carrier can be used. Digital source modulation can be performed at any date rate in bits per second up to eight times the modulation bandwidth in Hertz, using suitable symbol transmission schemes. Analog modulation can also be performed. A monolithic or discrete-component power amplifier can be incorporated after the modulator to boost the output power. Linear or circular polarization can be used in any combination with carrier frequencies to provide polarization and frequency diversity between transmitter and receiver channels. A pair of dishes can be used instead of a single dish to provide spatial diversity in a single transceiver as well.

The MMW Gunn diode and MMW amplifier can be made on indium phosphide, gallium arsenide, or metamorphic InP-on-GaAs. The MMW amplifier can be eliminated completely for short-range links. The detector can be made using silicon or gallium arsenide. The mixer/downconverter can be made on a monolithic integrated circuit or fabricated from discrete mixer diodes on doped silicon, gallium arsenide, or indium phosphide. The phase lock loop can use a microprocessor-controlled quadrature (I/Q) comparator or a scanning filter. The detector can be fabricated on silicon or gallium arsenide, or can comprise a heterostructure diode using indium antimonide.

The backup transceivers can use alternate bands 5.9-6.9 GHz, 17.7-19.7 GHz, or 21.2-23.6 GHz; all of which are covered under FCC Part 101 licensing regulations. The antennas can be Cassegrain, offset or prime focus dishes, or flat-panel slot array antennas, of any size appropriate to achieve suitable gain.

While the above description contains many specifications, the reader should not construe these as a limitation on the scope of the invention, but merely as exemplifications of preferred embodiments thereof. For example, the full allocated MMW band referred to in the description of the preferred embodiment described in detail above along with state of the art modulation schemes may permit transmittal of data at rates exceeding 10 Gbits per second. Such data rites would permit links compatible with 10-Gigabit Ethernet, a standard that is expected to become practical within the next two years. The present invention is especially useful in those locations where fiber optics communication is not available and the distances between communications sites are less than about 15 miles but longer than the distances that could be reasonably served with free space laser communication devices. Ranges of about 1 mile to about 10 miles are ideal for the application of the present invention. However, in regions with mostly clear weather the system could provide good service to distances of 20 miles or more. Accordingly the reader is requested to determine the scope of the invention by the appended claims and their legal equivalents, and not by the examples given above.

What is claimed is:

1. A point-to-point millimeter wave communications system comprising:
A) a first millimeter wave transceiver system located at a first site capable of transmitting and receiving to and from a second site through atmosphere digital information at rates in excess of 155 million bits per second during normal weather conditions, said first transceiver comprising a first tracking flat panel antenna producing a beam having a half-power beam width of about 2 degrees or less,
B) a second millimeter wave transceiver system located at said second site capable of transmitting and receiving to and from said first site digital information at rates in excess of 155 million bits per second during normal weather condition, said second transceiver comprising a second tracking flat panel antenna producing a beam having a half-power beam width of about 2 degrees or less.

2. A system as in claim 1 wherein at least one of said tracking flat panel antennas comprises a monopulse tracking system.

3. A system as in claim 1 wherein each of said first and said second tracking flat panel antennas comprises a monopulse tracking system.

4. A system as in claim 1 wherein at least one of said tracking flat panel antennas comprises a conical scan tracking system.

5. A system as in claim 1 wherein at least one of said tracking flat panel antennas comprises a sequential lobing tracking system.

6. A system as in claim 1 wherein said first transceiver system is configured to transmit and receive information at frequencies greater than 57 GHz.

7. A system as in claim 1 wherein said first transceiver system is configured to transmit and receive information at frequencies greater than 90 GHz.

8. A system as in claim 1 wherein said first transceiver system is configured to transmit and receive information at frequencies between 92 and 95 GHz.

9. A system as in claim 1 wherein one of said first and second transceiver systems is configured to transmit at frequencies in the range of about 92.3 to 93.2 GHz and to receive information at frequencies in the range of about 94.1 to 95.0 GHz.

10. A system as in claim 1 and further comprising a back-up transceiver system operating at a data transmittal rate of less than 155 million bits per second configured continue transmittal of information between said first and second sites in the event of abnormal weather conditions.

11. A system as in claim 10 wherein said backup transceiver system is a microwave system.

12. A system as in claim 12 wherein said backup transceiver system is configured to operate in the frequency range of 10.7 to 11.7 GHz.

13. A system as in claim 12 wherein said backup transceiver system is configured to operate in the frequency range of 5.9 to 6.9 GHz.

14. A system as in claim 12 wherein said backup transceiver system is configured to operate in the frequency range of 13 to 23 GHz.

15. A system as in claim 1 wherein said first and said second sites are separated by at least one mile.

16. A system as in claim 1 wherein said first and said second sites are separated by at least 2 miles.

17. A system as in claim 1 wherein said first and said second sites are separated by at least 7 miles.

18. A system as in claim 1 wherein said first and said second sites are separated by at least 10 miles.

19. A system as in claim 1 wherein each of said first and said second transceiver are configured to transmit and receive information at bit error ratios of less than 10⁻¹⁰ during normal weather conditions.

20. A system as in claim 1 wherein said first and second systems are capable of transmitting and receiving at rates in excess of 1 billion bits per second and the antennas of both systems are configured to produce beam having half-power beam widths of about 0.36 degrees or less.
